(19) United States
(12) Patent Application Publication
(10) Pub. No.: US 2010/0183929 A1
(43) Pub. Date: Jul. 22, 2010

(54) SOLID OXIDE FUEL CELL SYSTEM INCLUDING A WATER BASED FUEL REFORMER

(75) Inventors: Aaron T. Crumm, Ann Arbor, MI (US); Timothy LaBreche, Ann Arbor, MI (US)

Correspondence Address: Adaptive Materials Inc., 5500 S. State Rd., Ann Arbor, MI, 48108, US

(73) Assignee: ADAPTIVE MATERIALS, INC., Ann Arbor, MI (US)

(21) Appl. No.: 12/701,733

(22) Filed: Feb. 8, 2010

Related U.S. Application Data
(63) Continuation-in-part of application No. 12/321,219, filed on Jan. 20, 2009.

(51) Int. Cl. H01M 8/18

(52) U.S. Cl. 429/423

(57) ABSTRACT

A solid oxide fuel cell system includes an electrochemical fuel cell, a fuel reformer and a hydrogen separation member. The electrochemical fuel cell includes a fuel electrode electrochemically generating water from hydrogen fuel and oxygen ions. The fuel reformer configured to receive a raw fuel stream and to react raw fuel and recycled water to form hydrogen fuel and exhaust gases. The hydrogen separation member is configured to separate hydrogen fuel from the exhaust gases such that the hydrogen fuel transported through the hydrogen separation member is routed from the hydrogen separation member to the fuel electrode. The hydrogen separation member partially defines a water recycle conduit configured to route water to the raw fuel stream upstream the fuel reformer.

### CROSS-REFERENCE TO RELATED APPLICATION

The present application is a continuation-in-part, and claims the benefit of U.S. patent application Ser. No. 12/321,219, which is hereby incorporated by reference in its entirety.

### FIELD OF THE INVENTION

The present disclosure is related to solid oxide fuel cell systems generating hydrogen in an internal reformer utilizing water recovery.

### BACKGROUND

The statements in this section merely provide background information related to the present disclosure and may not constitute prior art.

Fuel cells have been developed for portable power applications to compete with portable generators, batteries, and other energy conversion devices. Fuel cells are advantageous over generators in that fuel cells can operate at higher fuel-to-energy conversion efficiency levels. In particular, a generator's efficiency is limited by a thermodynamically defined efficiency ceiling defined by the generator's thermal cycling. Because fuel cells convert a fuel's chemical energy directly to electrical energy, fuel cells can operate at efficiency levels that are much higher than generators at comparable power levels. Further, portable generator systems generally do not efficiently meet power and energy requirements for applications requiring low amounts of continuous power, for example less than one kilowatt of continuous power, wherein a fuel cell system can operate efficiently within this power range.

Portable fuel cell systems can meet power and energy requirements that are not met by either batteries or other energy conversion devices. For example, high-efficient lithium ion batteries can have more than ten times the weight-to-energy ratio as an energy equivalent fuel cell system inclusive of three days of fuel.

Improvements in performance and cost reduction will enable the large-scale adoption of fuel cells in the commercial marketplace. Areas for fuel cell performance improvement include fuel cell system weight improvements, fuel cell fuel efficiency improvements, and fuel cell durability improvements. Areas of cost improvements include reducing material costs, improving high volume manufacturing efficiency, decreasing fuel consumption, and decreasing operating costs.

The following description and figures sets forth a fuel cell system having improvements in performance and cost, which will progress adoption of fuel cell systems in the commercial applications.

### SUMMARY

A solid oxide fuel cell system includes an electrochemical fuel cell, a fuel reformer and a hydrogen separation member. The electrochemical fuel cell includes a fuel electrode electrochemically generating water from hydrogen fuel and oxygen ions. The fuel reformer is configured to receive a raw fuel stream and to react raw fuel and recycled water to form hydrogen fuel and exhaust gases. The hydrogen separation member is configured to separate hydrogen fuel from the exhaust gases such that the hydrogen fuel transported through the hydrogen separation member is routed from the hydrogen separation member to the fuel electrode. The hydrogen separation member partially defines a water recycle conduit configured to route water to the raw fuel stream upstream the fuel reformer.

### BRIEF DESCRIPTION OF THE DRAWINGS

FIG. 1A depicts a prospective view of a fuel cell system in accordance within an exemplary embodiment of the present disclosure;

FIG. 1B depicts an exploded prospective view of the fuel cell system of FIG. 1;

FIG. 2 depicts a cross-sectional view of the fuel cell system of FIG. 1A;

FIG. 3 depicts a cross-sectional view of a fuel cell system in accordance with another exemplary embodiment of the present disclosure;

FIG. 4 depicts a cross-sectional view of a portion of the fuel cell system of FIG. 2 illustrating representative reaction yields when operating in a steam reforming operating mode;

FIG. 5 depicts a cross-sectional view of a portion of the fuel cell system of FIG. 2 illustrating representative reaction yields when operating in an autothermal reforming operating mode;

FIG. 6 depicts a cross-sectional view of a portion of the fuel cell system of FIG. 2 illustrating representative reaction yields when operating in a partial oxidation reforming mode; and

FIG. 7 depicts a cross-sectional view of a fuel cell tube of the fuel cell system of FIG. 1.

It should be understood that the appended drawings are not necessarily to scale, presenting a somewhat simplified representation of various preferred features illustrative of the basic principles of the invention. The specific design features of the electric power generation device will be determined in part by the particular intended application and use environment. Certain features of the illustrated embodiments have been enlarged or distorted relative to others for visualization and clear understanding. In particular, thin features may be thickened, for example, for clarity of illustration.

### DETAILED DESCRIPTION OF THE EMBODIMENTS

In one exemplary embodiment, disclosed herein is a fuel cell system configured to operate at high fuel efficiency levels. In one embodiment, an exemplary fuel cell system is configured to operate utilizing onboard partial oxidative reforming. In one embodiment, an exemplary fuel cell is configured to operate utilizing onboard autothermal reforming. In one embodiment, an exemplary fuel cell system is configured to operate utilizing onboard steam reforming. The exemplary fuel cell systems can operate in startup, shutdown and other transient operating modes.

In one embodiment, an exemplary fuel cell system is configured to operate utilizing multiple operating modes, wherein the operating modes include partial oxidative reforming mode, autothermal reforming mode, and steam reforming mode. Further, hydrogen generation, water generation and hydrogen separation each occur within a solid oxide fuel cell tube. Exemplary fuel cell systems are configured to operate in at least one of autothermal reforming mode and steam reforming mode without requiring an onboard water storage tank. However, in alternate embodiments, an onboard water storage tank may be utilized to supplement or assist in the autothermal and steam reforming processes. The exemplary portable fuel cells can recycle water produced from the fuel cell reactions for onboard reforming.

As used herein, the term “partial oxidation,” refers to a process wherein a raw fuel and air are provided in a substoichiometric fuel-to-air mixture, wherein the fuel is partially combusted to form carbon monoxide and hydrogen gases. Although, generally referred to throughout the specification as partial oxidation, the partial oxidation mode can further include processes in which a portion of the raw fuel is partially combusted and a portion of the raw fuel is fully combusted by oxygen.

As used herein, the term “autothermal reforming” refers to a process in which oxygen and steam (water vapor) are reacted with a raw fuel to form hydrogen gas and carbon monoxide. Raw fuel can include any of a wide variety molecules comprising hydrogen and carbon for example, hydrocarbons and oxygenated hydrocarbons, and in particular, methanol, ethanol, butane, propane, octane, kerosene, gasoline, diesel fuel, JP-8 fuel and the like.

As used herein, the term “steam reforming” refers to a process in which steam (water vapor) is reacted with a raw fuel to form hydrogen gas in a low oxygen environment or a substantially oxygen-free environment.

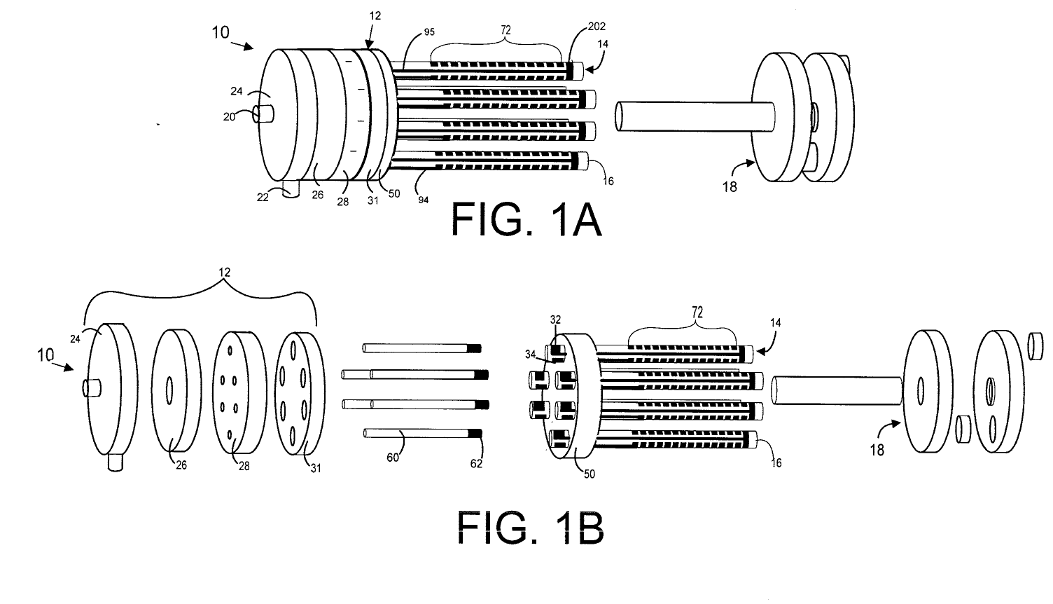

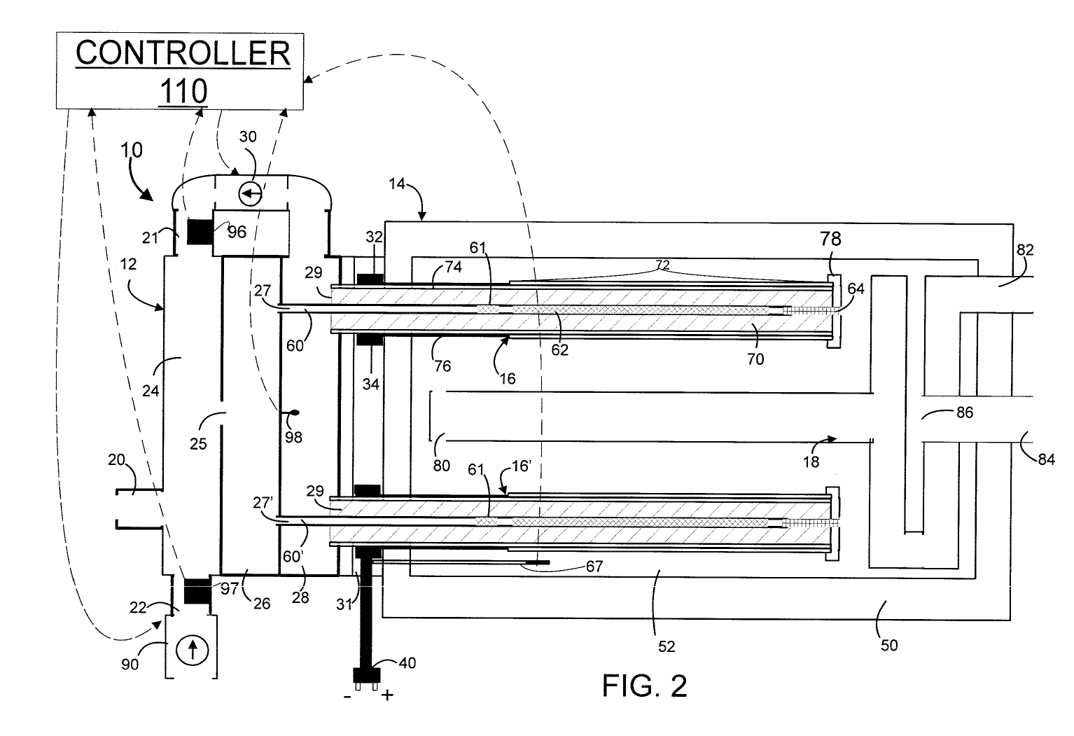

Referring to FIG. 1A, FIG. 1B, and FIG. 2 a solid oxide fuel cell system 10 includes a manifold 12, a fuel cell stack 14 and a controller 110. The fuel cell system 10 further includes balance of plant components including a cathode air pump, (not shown) and various other actuators, valves, sensors, electrical transfer components, and control components not depicted in the figures. The exemplary fuel cell system 10 is a portable fuel cell system configured for human or vehicle transport. However, features of exemplary fuel cell system described herein are also applicable to stationary fuel cell systems.

The manifold 12 comprises a mixing portion 24, a distribution portion 26, a water collection portion 28, a conduit 21, an electrical connector portion 31, mass flow sensors 96 and 97, a humidity sensor 98, an anode air pump 90, and a water pump 30. The manifold 12 receives air through the air inlet 22 and raw fuel through the fuel inlet 20. Water enters the collection chamber 28 of the manifold 12 through the water inlet 29. Water concentration within the collection chamber 28 can be measured utilizing the humidity sensor 98. In alternate embodiment, water from an external water source can be introduced to the mixing chamber 12 through the fuel inlet 20 or through a second water inlet (not shown).

The fuel cell stack 14 includes an insulative body 50 defining an insulative chamber 52, a plurality of fuel cell tubes (each of which are generally described with reference to fuel cell tube 16), a plurality of fuel feed tubes (each of which are generally described with reference to fuel feed tube 60), a heat recuperator 18, a cap member 78, and a thermocouple 67. The fuel cell stack 14 further includes a partial oxidation reformer 61 and a water-based reformer 62, each of which are disposed within each fuel feed tube 60, and a hydrogen separation membrane 64 extending out of each fuel feed tube 60. In an alternate embodiment, the hydrogen separation 64 member is integrated into the fuel feed tube 60, wherein a porous portion of the fuel feed tube is coated with hydrogen separation material (e.g., a palladium membrane) to provide hydrogen separation functionality.

The partial oxidation reformer 61 comprises a catalytic material composition and microstructure configured for partial oxidation reforming, and the water-based reformer comprises a catalytic material composition and microstructure configured for autothermal and steam reforming. However, water-based reforming reactions may occur at the partial oxidation reformer 61 and partial oxidation reforming reaction may occur at the water-based reformer 62. Further, although fuel cell stack 14 includes two separate reformers comprising catalytic material optimized for specific reforming processes, in alternate embodiments, a single reformer comprising single or multiple catalytic material compositions can be utilized for both partial oxidation and water-based reforming.

During operation, recycled water is routed from the collection chamber 28 to the mixing chamber 24 through a conduit 21, and water can be motivated from the collection chamber 28 to the mixing chamber 24 by the water pump 30. The mixing chamber 24 can receive water from the conduit 21, fuel from the fuel inlet 20 and air from the air inlet 22, and fuel is mixed with at least one of air and water in the mixing chamber 24. Fuel along with air and/or water are routed through a distribution chamber inlet 25 and through the distribution chamber into each fuel feed tube inlet 27. In an alternate embodiment, a pressure difference, for example pressure gradients resulting from water concentrations gradients within the manifold 12 can motivate the water through the manifold 12 without utilizing a pump, blower, or the like.

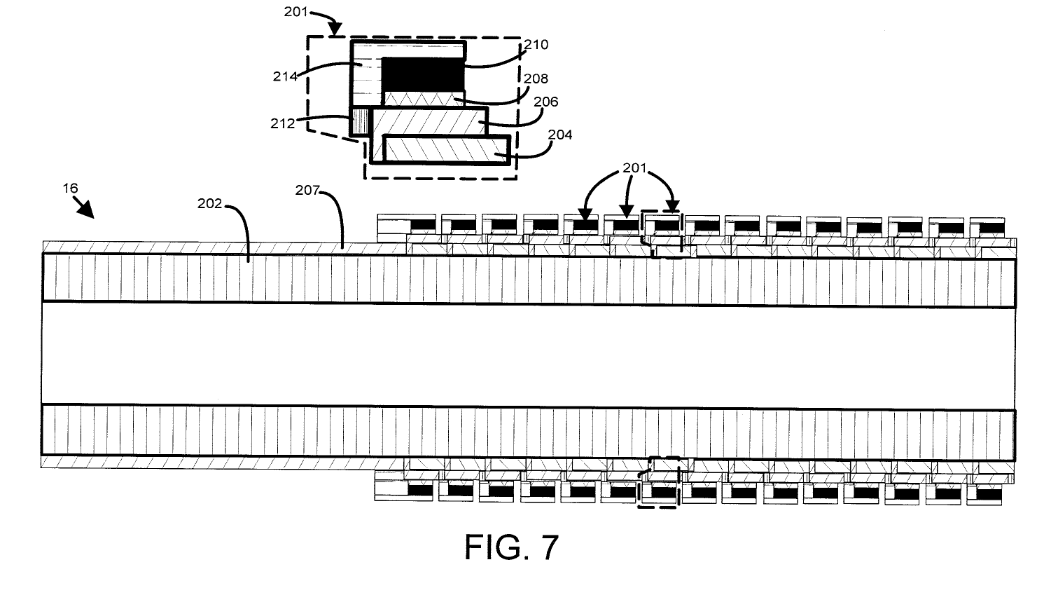

The heat recuperator 18 is provided to transfer heat between fuel cell exhaust and incoming cathode air to the insulated chamber 52. The cathode air is routed to cathode portions (depicted as 210 in FIG. 7) of the fuel cell tubes 16 and is utilized as an electrochemical reactant for reactions at the cathode of the fuel cell tubes 16. The heat recuperator includes an air inlet 82, an air outlet 80, an exhaust inlet 86, and an exhaust outlet 84.

The fuel feed tube 60 extends from the distribution chamber 26 into the insulation chamber 52. The fuel feed tube 60 is disposed in a fuel cell tube 16, wherein the fuel cell tube 16 extends from the water recycle chamber 28 into the insulated chamber 52.

The insulative body 50 can comprise high-temperature, ceramic-based material for example, foam, aero-gel, mat-materials, and fibers formed from, for example, alumina, silica, and like materials.

The fuel feed tube 60 can comprise a dense ceramic material compatible with the high operating temperatures within the insulated chamber 52, for example, an alumina based material or a zirconia based material. In an alternate embodiment the fuel feed tube can comprises metallic materials and can, for example, be utilized as current collectors for the fuel cell electrodes.

The partial oxidation reformer 61 and the water-based reformer 62 each comprise a metallic catalyst material such as platinum, rhodium, rubidium, nickel and the like disposed on a ceramic substrate such as an alumina or a zirconia substrate. Each partial oxidation reformer 61 and the water-based reformer 62 can be designed and located within the fuel feed tube to manage catalytic reactions and thermal distribution within the fuel stack 14. Material compositions for the partial oxidation reformer 61 and the water-based reformer 62 capable of the operating characteristics described above will be apparent to those skilled in the art.

The hydrogen separation member 64 is disposed at an end of the fuel feed tube 60 and extends out an end of the fuel feed tube 60 such that hydrogen can travel from an outer circumference hydrogen separation member 64 to an anode of the fuel cell tube 16. The hydrogen separation member 64 comprises a hydrogen separation layer including palladium or a palladium alloy. Exemplary palladium alloys can comprise palladium along with one or more of titanium, copper, silver, vanadium, yttrium. In one embodiment, a hydrogen separation member includes a hydrogen separation layer comprising an alloy including zinc and nickel.

In an alternate embodiment, the hydrogen separation member comprises an electrically conductive matrix, a support member and/or a proton conducting matrix. In an exemplary embodiment, the electrically conductive matrix comprises primarily nickel metal. In an alternative exemplary embodiment, the electrically conductive matrix comprises a palladium or a nickel-palladium matrix. The electrically conductive matrix can further comprise dopants to increase the durability of the electrically conductive matrix. The desired ratio of the electrically conductive matrix material to proton conducting carrier material for conducting hydrogen ions across the hydrogen separation member 64 can be determined based on the percolation limit, the proton conductivity of the proton conducting carrier, and the electrical conductivity of the electrically conductive matrix. The support layer comprises porous material generally compatible with proton conducting layer (including compatible with thermal expansion properties and including low reactivity) and with the operating environment of the hydrogen separation member. In one embodiment, the support layer comprises yttria stabilized zirconia. In alternate embodiment, the support material can comprise other material.

In another alternate embodiment, the hydrogen separation member 64 can include perovskite materials represented by the general formula AB₁₋ₓMₓO_{3-δ} (where A is a divalent cation such as Sr or Ba, B is Ce or Zr, M is a fixed-valent dopant such as Y, Yb, Nd, or Gd), and proton conduction within the perovskite material can be induced through the substitution of trivalent dopant ions on the B site. This substitution results in the formation of vacant oxygen sites, or in oxidizing atmospheres, the creation of electron holes. Mobile protons can then be introduced through the uptake hydrogen ions that are generated at the fuel reforming catalysts. In alternate embodiments, hydrogen can be separated utilizing membranes that function utilizing various other mechanisms. In one embodiment, hydrogen migrates between a first side and a second side of the membrane comprising a lattice structure by migrating between interstitial sites of the lattice structure.

As depicted in FIGS. 1A, 1B, 2, 4, 5, 6, and 7, in one embodiment, the fuel cell system 10 includes solid oxide fuel cell tubes 16 having multiple active areas electrically interconnected in series (“cell-in-series design”). Referring to FIG. 7, the fuel cell tube 16 includes a support portion 202, a gas barrier portion 207, and a plurality of cells units 201. Each cell unit 201 includes an anode portion 204, an electrolyte portion 206, an intermediate portion 208, a cathode portion 210, an interconnect portion 212, and a current collector portion 214. Collectively for each fuel cell tube 16, the anode portions 204 are referred to as “anode” herein, the electrolyte portions 206 are referred to as “electrolyte” herein and the cathode portions 210 are referred to as “cathode” herein. The support portion 202 can be formed through extrusion processes, pressing processes, casting processes, and like processes for forming ceramic members. For an exemplary thermoplastic extrusion processes see U.S. Pat. No. 6,749,799 to Crumm et al, entitled METHOD FOR PREPARATION OF SOLID STATE ELECTROCHEMICAL DEVICE, the entire contents of which is hereby incorporated by reference, herein.

In an exemplary thermoplastic ceramic extrusion process for forming support portion 202, a compound is prepared from 85.9 weight percent of 8 mole % yttria stabilized zirconia powder, 7.2 weight percent of polyethylene polymer, 5.3 weight percent of acrylate polymer, 1.0 weight percent of stearic acid, and 0.3 weight percent of heavy mineral oil, 0.3 weight percent of polyethylene glycol of a molecular weight of 1000 grams per mole. The microstructure and porosity of the support portion 202 can be tailor for desired gas diffusion and for compatibility with other portions of the fuel cell tube 16 including the electrolyte portion 206 and the barrier portion 207. The exact microstructure and porosity of the support portion 202 can be controlled in several ways, including through the sintering temperature, particle size distribution of the ceramic powder and by the use of pore-forming additives, such as carbon particles or similar pore-formers.

The anode portion 204 comprises an electrically and ionically conductive cermet that is chemically stable in a reducing environment. In an exemplary embodiment, the anode portion 204 comprises a conductive metal such as nickel, disposed within a ceramic skeleton, such as yttria-stabilized zirconia.

Exemplary materials for the electrolyte portion 206 and electrolyte portion 207 include lanthanum-based materials, zirconium-based materials and cerium-based materials such as lanthanum strontium gallium manganite, yttria-stabilized zirconia and gadolinium doped ceria, and can further include various other dopants and modifiers to affect ion conducting properties. The anode portion 204 and the cathode 210, which form phase boundaries (gas/electrolyte/electrode particle; commonly known as triple points) with the electrolyte portion 206 and are disposed on opposite sides of the electrolyte portion 206 with respect to each other.

The electrolyte portion 206 is disposed both on a surface of the anode portion 204 parallel to the anode portion 204 and abutting the anode portion 204. The section of the electrolyte portion 206 parallel to the anode portion provides an ion conduction pathway and electron insulation between the anode portion 204 and the cathode portion 210. The section of the electrolyte 204 abutting the anode portion 204 provides electron insulation between anode portions of separate cell units 201.

In general, the anode portion 204 and cathode portion 210 are formed of porous materials capable of functioning as an electrical conductor and capable of facilitating the appropriate reactions. The porosity of these materials allows dual directional flow of gases (e.g., to admit the fuel or oxidant gases and permit exit of the byproduct gases).

The cathode comprises a conductive material chemically stable in an oxidizing environment. In an exemplary embodiment, the cathode comprises a perovskite material and specifically lanthanum strontium cobalt ferrite (LSCF). In an exemplary embodiment, each of the anode, electrolyte, and cathode are disposed within a range, of about 5-50 micrometers. An intermediate layer 208 may be disposed between the cathode portion 210 and the electrolyte portion 206 to decrease reactivity between material in the cathode portion 210 and material in the electrolyte portion 206. In an exemplary embodiment, the intermediate portion 208 comprises strontium-doped cobaltate (SDC), and is disposed at a thickness within the range of 1-8 micrometers.

The interconnection portion 212 electrically connects an anode of a cell unit to a cathode of a separate cell unit such that electrons can be conducted in series between the cell units. In an exemplary embodiment the interconnection portion comprises platinum. The current collector portion 214 conducts electrons across the cathode portion 210. In an exemplary embodiment, the current collector portion comprises a silver palladium alloy.

The exemplary fuel cell tube 16 can be manufactured utilizing a screen printing process wherein each portion is screen-printed utilizing one or more screen printing pattern per portion, and wherein each portion is then fired individually or co-fired with other portions. The term “pattern” used in the following refers to material deposition arrangements that either individually or along with complementary patterns form the anode portion 204, electrolyte/barrier portion 206, the intermediate portion 208, the cathode portion 210, the interconnect portion 212, and the current collector portion 214. In an exemplary embodiment, an anode portion pattern, a first electrolyte/barrier layer pattern, a second electrolyte barrier layer pattern, and an interconnect are printed in sequence with a low temperature drying step between each step. The anode pattern, the first electrolyte/barrier layer pattern, the second electrolyte barrier layer pattern, and the interconnect pattern are co-fired at a temperature of about 1200-1600 degrees Celsius to form a first sintered composite.

An intermediate pattern is printed on the first sintered composite and fired at a firing temperature of about 1150-1400 degrees Celsius to form a second sintered composite. A cathode pattern, a first current collector pattern, and a second current collector pattern are printed on the second sintered composite. The cathode pattern, the first current collector pattern, and the second current collector pattern are printed on the second sintered composite and are fired at a firing temperature of about 950 degrees Celsius to about 1200 degrees Celsius.

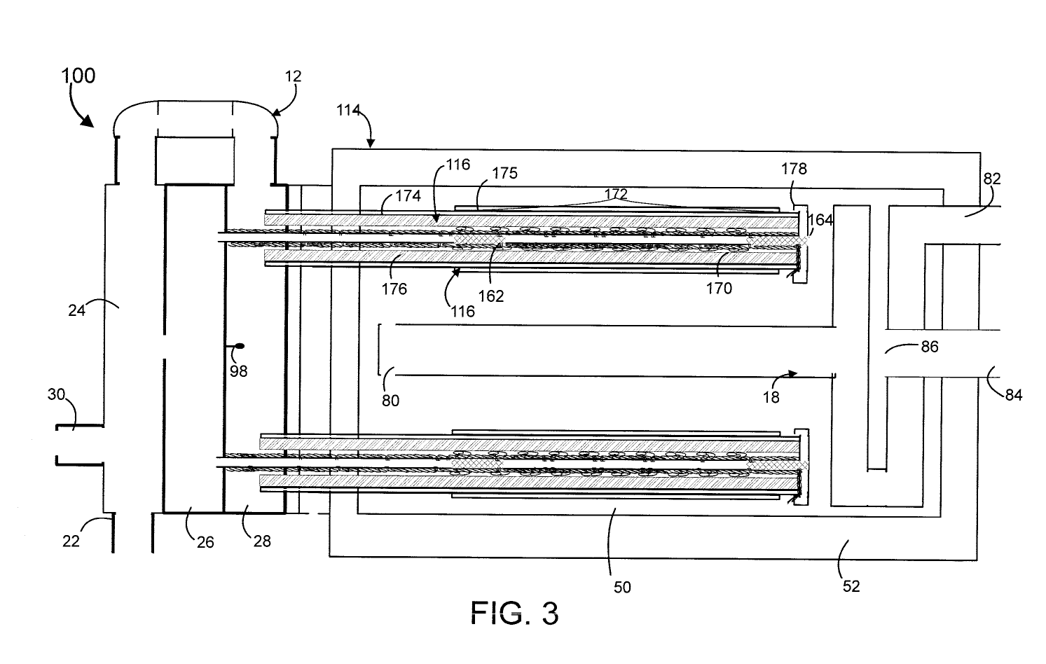

As depicted in FIG. 3, another exemplary fuel cell system 100 comprises the manifold 12 and a fuel cell stack 114. The fuel cell stack 114 comprises substantially similar components to the fuel cell stack 14 described above, except in that the fuel cell stack 114 includes fuel cell tubes 116 comprising a single electrochemical cell over a continuous active area 172 and in that the fuel cell stack 114 includes internal current collectors 162 and external current collectors (not shown). Each fuel cell tube 116 includes an anode layer 176, an electrolyte layer 174, and a cathode layer 175. The anode layer comprises substantially similar material to the anode portion 204 of the fuel cell tube 16, and the electrolyte layer 174 comprises substantially similar material to the electrolyte portion 206 of the fuel cell tube 16. The cathode layer 175 comprises substantially similar material to the cathode portion 210 and an intermediate layer (not shown) comprises substantially similar material to the intermediate portion 208. The portion of the fuel cell tube having the cathode layer 175 defines the active area 172. The fuel cell stack 114 can comprises fuel cell tubes similar to those described in U.S. Pat. No. 6,749,799 to Crumm et al.

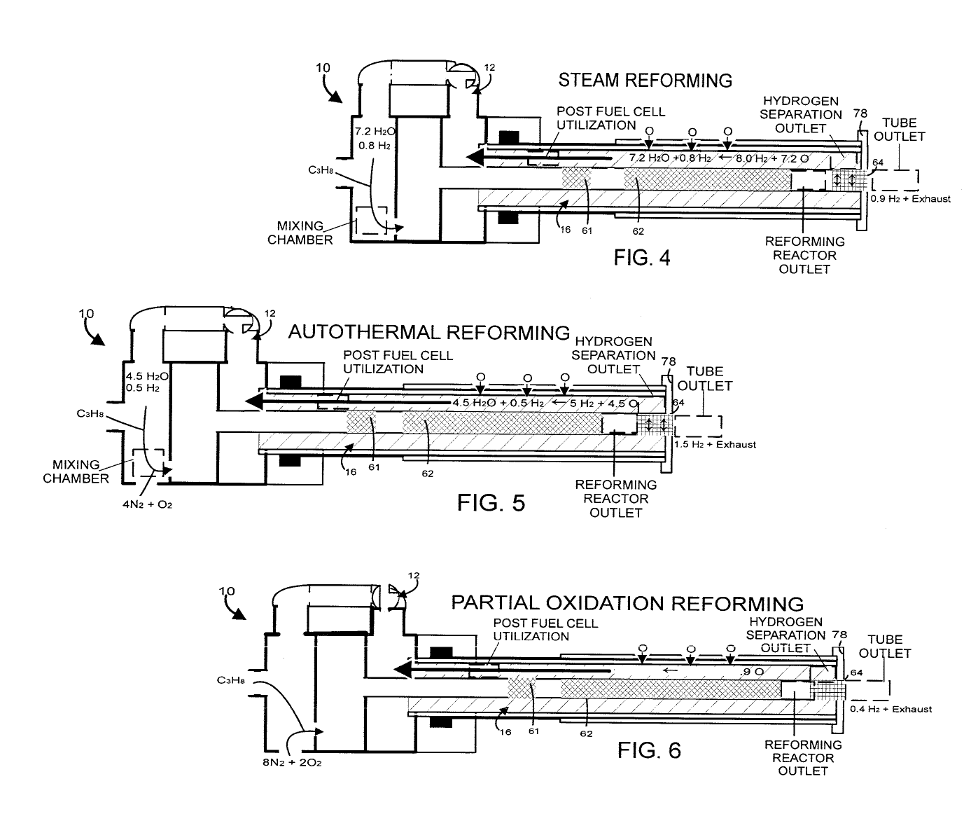

Referring to FIG. 4 and Table 1 below the exemplary fuel cell system 10 can generate molecular species at representative, substantially consistent exemplary levels while operating at steady-state in a steam reforming mode.

TABLE 1
Steady-State Steam Reforming Mode

| | | Inside Tube | | Hydrogen | Post Fuel |
|---|---|---|---|---|---|
| | Mixing | and Post | Tube | Separation | Cell |
| Species | Chamber | Reformers | Outlet | Outlet | Utilization |
| H2 | 0.8 | 8.9 | 0.9 | 8.0 | 0.8 |
| H2O | 7.2 | 2.7 | 2.7 | 0 | 7.2 |
| C3H8 | 1.0 | 0 | 0 | 0 | 0 |
| LIGHT HC | 0 | 0.1 | 0.1 | 0 | 0 |
| CO | 0 | 0.9 | 0.9 | 0 | 0 |
| CO2 | 0 | 1.8 | 1.8 | 0 | 0 |
| O2 | 0 | 0 | 0 | 0 | 0 |
| N2 | 0 | 0 | 0 | 0 | 0 |

The column headings of Tables 1, 2, and 3 refer to molar ratios of molecular species “Species” and to locations of the fuel cell system 10 as depicted in FIGS. 3, 4, and 5, respectively. In particular, “Mixing Chamber” refers to a location within the mixing chamber 24, “Reforming Reactor Outlet” refers at an outlet of the water-based reformer 62 and downstream the partial oxidation reformer 61, “Tube Outlet” refers to an outlet of the fuel cell tube 16, “Hydrogen Separation Outlet” refers to a location at an outlet of the hydrogen separation member 64 and “Post Fuel Utilization” refers to location within porous ceramic portion of the fuel cell tube 16 downstream the active area 72.

In the exemplary steam reforming mode, the internal reformer continually converts 90% of the propane to hydrogen. Further, 90% of the hydrogen generated in the internal reformer 62 is retained within the system and 10% escapes from the system either through exhaust stream (as shown) or through openings in other parts of the fuel cell system 10. Further, the fuel cell system 10 operates at 90% fuel cell fuel utilization, that is, 90% of the hydrogen delivered to inner electrodes (i.e., the anode portion or the anode layers described above) is utilized in electrochemical reactions generating water and 10% of the hydrogen remains unreacted. “Light HC” refers to light hydrocarbon molecular components provided by incomplete oxidation of propane within the partial oxidation reformers 61 and the water based reformer 62.

Heat is generated by electrical resistance within the fuel cell tubes 16 and by combustion of combustible exhaust components within the insulated chamber 50. Heat is consumed by the endothermic steam reforming reactors within the internal reformer. The thermocouple 67 (FIG. 2) is disposed within the fuel cell stack to monitor temperature proximate the partial oxidation reformers 61 and the water based reformer 62. Therefore, the heat levels within the fuel cell stack can be controlled to maintain thermal equilibrium based on signals from the temperature sensor 67 by controlling the current draw from the fuel cell tubes, along with controlling air flow rates and fuel flow rate in the fuel cell stack.

Referring to FIG. 5 and Table 2 below, the exemplary fuel cell system 10 can generate molecular species at the representative, substantially consistent levels while operating at steady-state in an auto-thermal reforming mode.

TABLE 2
Steady-State Autothermal Reforming Mode

| | | Inside Tube | | Hydrogen | Post Fuel |
|---|---|---|---|---|---|
| | Mixing | and Post | Tube | Separation | Cell |
| Species | Chamber | Reformers | Outlet | Outlet | Utilization |
| H2 | 0.5 | 6.5 | 1.5 | 5.0 | 0.5 |
| H2O | 4.5 | 1.5 | 1.5 | 0 | 4.5 |
| C3H8 | 1.0 | 0 | 0 | 0 | 0 |
| vLIGHT HC | 0 | 0.25 | 0.25 | 0 | 0 |
| CO | 0 | 0.75 | 0.75 | 0 | 0 |
| CO2 | 0 | 1.5 | 1.5 | 0 | 0 |
| O2 | 1.0 | 0.62 | 0.62 | 0 | 0 |
| N2 | 4.0 | 4.0 | 4.0 | 0 | 0 |

In the exemplary autothermal reforming mode, the combined reformers 61 and 62 continually converts 75% of the propane to hydrogen. Further, 77% of the hydrogen generated in the reforming reactor is retained within the system and 23% escapes from the system either through exhaust stream (as shown) or through openings in other parts of the fuel cell system. Further, the fuel cell system 10 operates at 90% fuel cell fuel utilization, that is, 90% of the hydrogen delivered to inner electrodes (i.e., the anode portion or the anode layers described above) is utilized in electrochemical reactions generating water.

Referring to FIG. 6 and Table 3 below the exemplary fuel cell system 10 can generate molecular species at the representative, substantially consistent, levels while operating at steady-state in a partial oxidation reforming mode.

TABLE 3
Steady-State Partial Oxidation Reforming Mode

| | | Inside Tube | | Hydrogen | Post Fuel |
|---|---|---|---|---|---|
| | Mixing | and Post | Tube | Separation | Cell |
| Species | Chamber | Reformers | Outlet | Outlet | Utilization |
| H2 | 0.0 | 2.4 | 0.2 | 2.2 | 2.0 |
| H2O | 0.0 | 0 | 0 | 0 | 0 |
| PROPANE | 1.0 | 0 | 0 | 0 | 0 |
| LIGHT | 0 | 0.4 | 0.4 | 0 | 0 |
| HC/CO2 | | | | | |
| CO | 0 | 1.8 | 1.8 | 0 | 0 |
| O2 | 2.0 | 1.1 | 1.1 | 0 | 0 |
| N2 | 8.0 | 8.0 | 8.0 | 0 | 0 |

In the exemplary partial oxidation reforming mode, the internal reformer continually converts 60% of the propane to hydrogen. Although each of the figures depict exemplary steady-state of the fuel cell system 10, it is to be understood that the fuel cell can dynamically adjust air, fuel, and power draw and is therefore, capable of establishing steady-state producing numerous steady-state levels. Further, the fuel cell can continuously dynamically adjust air, fuel and power draw levels thereby dynamically changing the level of species within the fuel cell system 10.

In one exemplary method for controlling the fuel cell system 10, the controller 110 detects a water vapor level measured by the water vapor sensor 98 and controls energy of the water pump 30 and the air pump 90 based on the measured water vapor level, thereby controlling the fuel cell system in one of the steam reforming operating modes, the autothermal operating modes and the partial oxidation reforming operating modes.

In order to achieve the steady-state operating modes described above, the fuel cell systems can utilize external energy sources such as external heaters (i.e., resistive heaters or combustive heaters), and external water sources. However, in one exemplary embodiment, the fuel cell system can achieve autothermal reforming and steam reforming without utilizing external energy source or external water sources.

The exemplary embodiments shown in the figures and described above illustrate, but do not limit, the claimed invention. It should be understood that there is no intention to limit the invention to the specific form disclosed; rather, the invention is to cover all modifications, alternative constructions, and equivalents falling within the spirit and scope of the invention as defined in the claims. Therefore, the foregoing description should not be construed to limit the scope of the invention.

1. A solid oxide fuel cell system comprising:
an electrochemical fuel cell producing electricity by reacting hydrogen fuel and oxygen ions to generate water;
a fuel reformer configured to receive a raw fuel stream and to react raw fuel and recycled water to form hydrogen fuel and exhaust gases;
a hydrogen separation member configured to separate hydrogen fuel from the exhaust gases such that the hydrogen fuel transported through the hydrogen separation member is routed from the hydrogen separation member to the fuel electrode, the hydrogen separation member partially defining a water recycle conduit configured to route water to the raw fuel stream upstream the fuel reformer.

2. The solid oxide fuel cell system of claim 1, wherein the fuel reformer is further configured to react raw fuel and oxygen to form hydrogen fuel and exhaust gases.

3. The solid oxide fuel cell system of claim 2, wherein the solid oxide fuel cell system is configured to operate in a first operating mode and a second operating mode, wherein the solid oxide fuel cell system reacts raw fuel and oxygen to form hydrogen fuel and exhaust gases when operating in the first operating mode, and wherein the solid oxide fuel cell system reacts raw fuel and both oxygen and water to form water when operating in the second operating mode.

4. The solid oxide fuel cell system of claim 2, wherein the solid oxide fuel cell system is configured to operate in a third operating mode, and wherein the solid oxide fuel cell system reacts raw fuel and water when operating in the third operating mode.

5. The solid oxide fuel cell system of claim 4, further comprising humidity sensor configured to detect a water level in the recycle stream.

6. The solid oxide fuel cell system of claim 5, wherein one of the first operating mode, the second operating mode, and the third operating mode is selected based on the water level detected by the humidity sensor.

7. The solid oxide fuel cell system of claim 5, wherein one of the first operating mode, the second operating mode, and the third operating mode is selected based on the water level determined by the current draw.

8. The solid oxide fuel cell system of claim 6, further comprising a controller an air actuator and a fuel actuator, the controller operably coupled to the humidity sensors, the air actuator, and the fuel actuator, the controller controlling an air actuator power level and a fuel actuator power level based on the water level detected by the humidity sensor.

9. The solid oxide fuel cell system of claim 1, wherein the electrochemical fuel cell is a fuel cell tube, and wherein the fuel reformer is disposed within the fuel cell tube.

10. The solid oxide fuel cell system of claim 9, further comprising a fuel feed tube configured to route raw fuel to the fuel reformer and route hydrogen fuel from the fuel reformer to the hydrogen separation member, where in the fuel reformer is disposed within the fuel feed tube.

11. The solid oxide fuel cell system of claim 8, wherein the hydrogen separation member is disposed within the fuel cell tube.

12. The solid oxide fuel cell system of claim 8, wherein fuel cell tube comprise multiple active areas coupled in series.

13. The solid oxide fuel cell system of claim 8 comprising a plurality of electrically connected fuel cell tubes.

14. The solid oxide fuel cell system of claim 13, wherein the fuel cell tubes are electrically connected utilizing diodes.

16. The solid oxide fuel cell system of claim 8, wherein the fuel cell tube comprises a single active area.

17. The solid oxide fuel cell system of claim 8, further comprising a cap member disposed at an exhaust end at a fuel cell tube, the cap member further defining the water recycle conduit.

18. The solid oxide fuel cell of claim 1, further comprising a manifold, the manifold comprising a mixing chamber, a distribution chamber and a water collection chamber.

19. A solid oxide fuel cell system comprising:
a plurality of fuel cell tubes producing electricity by reacting hydrogen fuel and oxygen ions to generate water;
a plurality of fuel reformers configured to receive a raw fuel stream and to react raw fuel and recycled water to form hydrogen fuel and exhaust gases; and
a plurality of hydrogen separation members configured to separate hydrogen fuel from the exhaust gases such that the hydrogen fuel transported through the hydrogen separation member is routed from the hydrogen separation member to the fuel electrode, the each hydrogen separation member partially defining a water recycle conduit configured to route water to the raw fuel stream upstream the fuel reformer.

20. The solid oxide fuel cell system of claim 19, wherein the plurality of fuel reformers are configured to react fuel, recycled water and external water to form hydrogen fuel and exhaust gases.
